(19) United States
(12) Patent Application Publication
(10) Pub. No.: US 2025/0356503 A1
(43) Pub. Date: Nov. 20, 2025

(54) INTERACTIVE OBJECT TRACKING AND ADJUSTMENT TECHNIQUES

(71) Applicant: Universal City Studios LLC, Universal City, CA (US)

(72) Inventor: Kevin Russell Bland, Orlando, FL (US)

(21) Appl. No.: 19/209,768

(22) Filed: May 15, 2025

Related U.S. Application Data
(60) Provisional application No. 63/648,501, filed on May 16, 2024.

(51) Int. Cl. G06T 7/20; G06T 7/60; G06T 7/70; G06T 17/00; H04N 23/11

(52) U.S. Cl. CPC G06T 7/20; G06T 7/60; G06T 7/70; G06T 17/00; H04N 23/11

(57) ABSTRACT

A method may include receiving input from an interactive object held by a user in an interactive environment. The method may also include determining a target point of the interactive object based on the input and a user-height parameter of the user. Additionally, the method may include adjusting the user-height parameter in response to the target point being outside an adjustment plane of the interactive environment.

### CROSS-REFERENCE TO RELATED APPLICATION

This application claims priority to and the benefit of U.S. Provisional Application No. 63/648,501, entitled “INTERACTIVE OBJECT TRACKING AND ADJUSTMENT TECHNIQUES” and filed May 16, 2024, which is incorporated by reference herein in its entirety for all purposes.

### BACKGROUND

This section is intended to introduce the reader to various aspects of art that may be related to various aspects of the present disclosure. This discussion is believed to be helpful in providing the reader with background information to facilitate a better understanding of the various aspects of the present disclosure. Accordingly, it should be noted that these statements are to be read in this light and not as admissions of prior art.

To improve guest experiences in an entertainment setting, the entertainment setting may often include objects (e.g., props or toys) that are interactive, provide special effects, or both. For example, the special effects may provide customized effects based on guests' experiences within the entertainment setting, as well as support a particular narrative in the entertainment setting. In certain interactive entertainment settings, guests may own or be associated with objects that interact with the interactive entertainment setting in various ways. In one example, a guest may interact with the interactive entertainment setting using an object with a form of a handheld device to generate a particular special effect.

### BRIEF DESCRIPTION

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

In an embodiment, a method may include receiving input from an interactive object held by a user in an interactive environment. The method may also include determining a target point of the interactive object based on the input from the interactive object and a user-height parameter of the user. Additionally, the method may include adjusting the user-height parameter in response to the target point being outside an adjustment plane of the interactive environment.

In an embodiment, an object tracking system for an interactive environment includes an interactive object held by a user in the interactive environment, a sensor that receives input indicative of the interactive object, and a controller communicatively coupled to the sensor. The controller may determine a target point of the interactive object based on the input and a user-height parameter of the user and adjust the user-height parameter based on the target point.

In an embodiment, one or more tangible, non-transitory, computer-readable media, includes instructions that, when executed by at least one processor, cause the at least one processor to identify input from an interactive object held by a user in an interactive environment, access a user profile associated with the user, the user profile including a user-height parameter of the user, determine a target point of an interactive object based on the input and the user-height parameter of the user, and adjust the user-height parameter in response to the target point being outside an adjustment plane of the interactive environment.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of an embodiment of an interactive object tracking and calibration system, in accordance with present techniques;

FIG. 2 is a schematic illustration of the interactive object tracking and calibration system of FIG. 1, in accordance with present techniques;

FIG. 3 is a schematic illustration of the interactive object tracking and calibration system of FIG. 1, in accordance with present techniques;

FIG. 4 is a schematic illustration of the interactive object tracking and calibration system of FIG. 1, in accordance with present techniques;

FIG. 5 is an illustration of a front view of the calibrated streaming plane of the interactive object tracking and calibration system of FIG. 1, in accordance with present techniques;

FIG. 6 is a flow chart of a method for determining a target point of an interactive object, in accordance with present techniques;

FIG. 7 is a flowchart of a method for adjusting a user-height parameter, in accordance with present techniques; and

FIG. 8 is a schematic illustration of the interactive object tracking and calibration system of FIG. 1, in accordance with present techniques.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” “having,” and “based on” are intended to be inclusive and mean that there may be additional elements other than the listed elements.

Users (e.g., guests) in an interactive environment (e.g., an immersive experience or an entertainment setting) may enjoy carrying objects (e.g., carrying, wearing, and/or holding objects, such as props; portable objects; guest objects; interactive objects), such as carrying handheld objects or wearing costume elements. The objects may be associated with a theme and may include a sword, wand, token, medallion, headgear, figurine, stuffed animal, clothing (e.g., hat), jewelry (e.g., necklace, bracelet, band), other portable object, or any combination thereof. Such objects may be utilized to facilitate interactions with the interactive environment. For example, certain movements of a toy sword may be detected as input that can initiate a special effect (e.g., display of imagery, such as animated characters; lighting; sounds; and/or haptic effects).

Such interactions in the interactive environment may be detected and controlled based on a sensor (or sensors) and/or control circuitry that recognizes the object inside the interactive environment (e.g., via object recognition and/or wireless communication). The control circuitry, which may include a controller, may control the object and/or operation of surrounding features based on recognition of the object, based on recognition of a pattern associated with the object (e.g., movement or operation of the object), or the like. In an embodiment, the sensor and/or control circuitry may be positioned external to the interactive environment, but control features within the interactive environment. While feedback (e.g., special effects) related to the object may often be provided via components that are separate from the object within the interactive environment, present embodiments may also operate to provide feedback (e.g., special effects) from within or on the object, which may facilitate a deeper level of user immersion into the interactive environment. Additionally, the objects may include on-board communication circuitry that, in operation, communicates object identification information (e.g., a unique identifier) and/or receives and sends wireless signals (e.g., data). Further, the objects may include one or more on-board emitters or any other suitable hardware or circuitry components to enable feedback (e.g., display of special effects) and interaction with the interactive environment.

In an embodiment, the interactive object control system may include an infrared (IR) camera as the sensor, as well as the control circuitry that may detect the objects using analysis of image data (e.g., IR camera images). In an embodiment, the control circuitry may also receive the object identification information via the wireless signals communicated over a particular radio frequency (e.g., range). For example, the control circuitry may analyze the image data to identify a point on an object (e.g., a tip of an interactive object). It may be challenging, however, to determine a desired interaction of a user based on the image data. For example, varying heights may affect the manner with which the user interacts with the interactive environment using the object. For example, because users of varied heights may move the object about varied ranges, two users pointing respective objects at different target objects in an interactive environment may be represented by the same image data (e.g., a point of reflected light at a location in space). Similarly, two users of different heights pointing at the same target object may be represented by different image data (e.g., different points of reflected light at different locations in space).

The systems and methods provided herein may provide an interactive object tracking and calibration system that tracks interactive objects to facilitate interaction between a user and an interactive environment. The tracking and calibration system may determine a target point in an interactive environment based on sensor data and one or more adjustable dimensions that represent a height of a user (also referred to herein as “a user-height parameter”). Further, the tracking and calibration system may adjust the adjustable dimensions based on the sensor data. For example, the tracking and calibration system may adjust a user-height parameter of a user (e.g., guest-height parameter) based on a target point indicated by the sensor data, such as in response to the target point indicated by the sensor data being outside of an area of expected user interest (e.g., window; frame). If the sensor data indicates a target point corresponding to a range of motion of a taller user, for instance, the tracking and calibration system may adjust tracking calculations of subsequent movements of the user accordingly by adjusting the user-height parameter. As such, the tracking and calibration system may adjust (e.g., calibrate) the user-height parameter to accurately track users of varying heights and/or reaches. In turn, this may enable the tracking and calibration system to more accurately account for the varying heights and/or reaches and to provide more immersive special effects, such as to actuate particular target objects (e.g., animated objects) that correspond to desired or intended interactions of the users, for example.

The interactive environment may be part of an amusement park, an entertainment complex, a retail establishment, and so forth. The disclosed systems and methods may include at least one or more interactive environments in a themed area having a common theme. Further, the disclosed systems and methods may include additional or other interactive environments having different themes, but that are within the same theme park or entertainment venue. In an embodiment, the interactive environment may be a live show, where the users are in the audience and may be able to participate in the live show using their objects. When referring to an interactive environment, the interactive environment may include a certain area of the theme park where users can interact with interactive elements within the certain area. Further, an interactive environment may also include different locations that are geographically separated from one another or that are dispersed throughout the theme park. The interactive environment may also be in a remote location. For example, the user may be able to establish an interactive environment at their home or any other location via an electronic device associated with the user (e.g., user electronic device; home console) that may interact with the object.

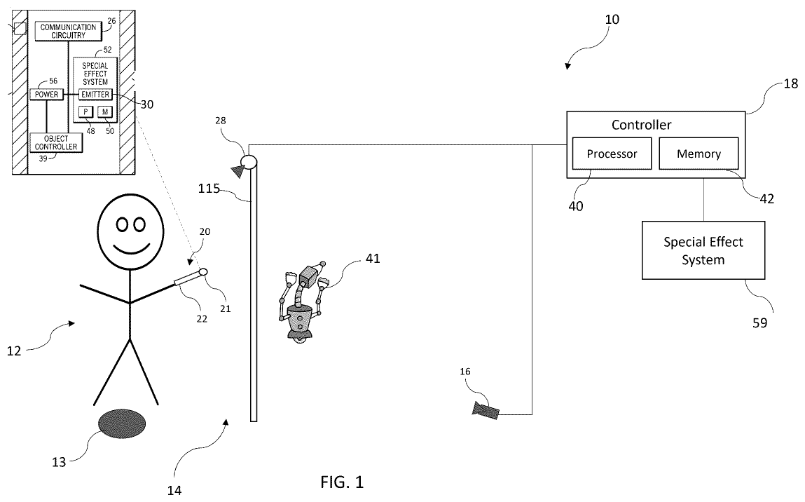

FIG. 1 is a schematic block diagram of an embodiment of an interactive object tracking and calibration system 10, in accordance with present techniques. In an embodiment, the interactive object tracking and calibration system 10 may receive or detect interactive object identification information, which may include a unique device identification number, light (e.g., infrared (IR) light), and the like, from an interactive object 20 in an interactive environment 14. The interactive environment 14 may include an area within a range for communication with one or more emitters 28 (e.g., light emitters, such as IR light emitters) and one or more sensors 16 (e.g., light detectors, such as an IR camera) of the interactive object tracking and calibration system 10. In an embodiment, the object identification information may be based on a detectable marker 21, which may be on a housing 22 of the interactive object 20. The detectable marker 21 may include reflective materials, retroreflective materials, and the like. That is, the detectable marker 21 may be detected by the interactive object tracking and calibration system 10 based on reflectivity, for example, such that the interactive object 20 provides tracking information as input passively. In an embodiment, the detectable marker 21 includes a single marker (e.g., one piece; point marker); however, it should be appreciated that the detectable marker 21 may include any suitable number of separate markers (e.g., 2, 3, 4, or more) in any suitable arrangement (e.g., spaced apart; in a pattern). Further, while the interactive object tracking and calibration system 10 is illustrated as including the one or more emitters 28, the one or more sensors 16, and the interactive object 20 with the detectable marker 21, the techniques described herein may be performed using any suitable components and/or devices that provide suitable data. For example, the interactive object 20 may include one or more on-board emitters 30 or any other suitable hardware or circuitry components that generate data used to track the interactive object 20 and/or adjust a user-height parameter of the user 12.

As illustrated, a user 12 (e.g., guest) may interact with the interactive object tracking and calibration system 10. The interactive object tracking and calibration system 10 includes the one or more emitters 28 (which may be all or a part of an emission subsystem having one or more emission devices and associated control circuitry) that emit one or more wavelengths of electromagnetic radiation (e.g., light, such as IR light, ultraviolet light, visible light; radio waves; and so forth). In an embodiment, the one or more emitters 28 may emit light within any suitable IR range that corresponds to a retroreflector range of the detectable marker 21 of the interactive object 20.

The interactive object tracking and calibration system 10 may also include the one or more sensors 16, which may, for example, include one or more cameras, that may capture reflected light from the detectable marker 21 of the interactive object 20. The one or more sensors 16 may detect light (e.g., limited to light within the 800 nm-1100 nm range; any suitable range, such as any suitable IR range). As noted, the interactive object 20 may include the detectable marker 21. The one or more sensors 16 may capture the reflected light from the interactive object 20 (e.g., capture the reflected light from the detectable marker 21 of the interactive object 20) and communicate data indicative of the reflected light to a controller 18 (e.g., electronic controller) of the interactive object tracking and calibration system 10. Then, the controller 18 of the interactive object tracking and calibration system 10 may determine a target point, and carry out various other operations as described herein.

In an embodiment, the user 12 may be positioned on or near a marker 13 (e.g., floor marking, medallion), such that the detectable marker 21 of the interactive object 20 may be within a range of the one or more emitters 28 and the one or more sensors 16. The user 12 may be instructed to stand on the marker 13 by, for example, an indication (e.g., a color, a textual indication) on the marker 13 and/or by other instructions within the interactive environment 14. The marker 13 may indicate a point along a progression through the interactive environment 14 of a themed attraction, for instance. In the illustrated embodiment, while the user 12 is positioned on the marker 13, components of the interactive object tracking and calibration system 10, such as the one or more sensors 16 and the controller 18, may be hidden from the user 12 behind a window 115 (e.g., transparent structure, semi-transparent structure). It should be noted that while the illustrated embodiment includes the one or more sensors 16, the one or more emitter 28, the window 115, the marker 13, and the interactive object 20 via which the user 12 may interact with the interactive object tracking and calibration system 10, in other embodiments, multiple interactive objects, sensors, emitters, windows, and markers may be included in the interactive object tracking and calibration system 10. For example, one or more users may move between multiple markers adjacent to multiple windows of an interactive environment, and multiple emitters and/or multiple sensors may enable the one or more users to use respective interactive objects to interact with the interactive environment.

Additionally, the one or more sensors 16 (which may be all or a part of a detection subsystem having one or more sensors, cameras, or the like, and associated control circuitry) may detect one or more of signals transmitted by the interactive object 20 and/or one or more wavelengths of electromagnetic radiation reflected by the interactive object 20 (e.g., emitted by the one or more emitters 28). To control operations of the one or more emitters 28 (e.g., an emission subsystem) and the one or more sensors 16 (e.g., a sensor subsystem), as well as to perform various signal processing routines resulting from the emission and detection processes, the interactive object tracking and calibration system 10 may also include the controller 18. The controller 18 may, for example, determine a target point of the interactive object 20 based on input from the one or more sensors 16 and a user-height parameter. However, the controller 18 may also adjust the user-height parameter based on the target point. For example, in response to determining that the target point is outside of a particular area (e.g., an area of user interest) when the target point is calculated with a first value of the user-height parameter, the controller 18 may reset or adjust the user-height parameter, which may then facilitate more accurate and user-specific determinations of the target point of the interactive object 20. The controller 18 may be directly or communicatively coupled to the one or more emitters 28 and/or the one or more sensors 16. As illustrated, the interactive object tracking and calibration system 10 may include the interactive object 20 (illustrated as a handheld object) that includes the housing 22, which may support the detectable marker 21. In an embodiment, an interior of the housing 22 may include communication circuitry 26. The communication circuitry 26 may include or be communicatively coupled with a radio frequency identification [RFID] tag.

As discussed here, the communication circuitry 26 may actively or passively communicate certain object identification information of the interactive object 20 to the one or more sensors 16 (e.g., RFID readers) in the interactive environment 14. In an embodiment, the communication circuitry 26 may include a RFID tag. In this way, the communication circuitry 26 may communicate the object identification information of the interactive object 20 to the one or more sensors 16 of the interactive environment 14. The one or more sensors 16 may, as an example, be implemented as receivers or RFID readers or any other suitable communication circuitry. The one or more sensors 16 may subsequently communicate the object identification information to the controller 18 of the interactive object tracking and calibration system 10. Generally, the communication circuitry 26 may enable wireless communication of the object identification information between respective hardware of the interactive object 20 and respective additional hardware of the interactive object tracking and calibration system 10 so that the object identification information that relates to one or both of a user profile and an object profile may be dynamically updated and used to generate personalized commands sent to the interactive object 20 and/or the interactive environment 14 from the controller 18.

In operation, the one or more sensors 16 may detect the interactive object 20 based on the detectable marker 21 on the interactive object 20 and/or via RF communications with the communication circuitry 26 of the interactive object 20. As noted, the one or more sensors 16 may detect reflected light from the detectable marker 21, and the controller 18 may determine a target point of the interactive object 20 within the interactive environment 14. Based on the determined target point, the controller 18 may cause a special effect within the interactive environment 14. For example, for a target point corresponding to a target object 41, the controller 18 may cause a visual change (e.g., appearance, disappearance, or movement) of the target object 41. In an embodiment, the controller 18 may communicate with an external special effect system 59 to cause the change in the interactive environment 14. It should be appreciated that the target object 41 may be a virtual object (e.g., in a virtual space; displayed via a display surface) and/or a physical object (e.g., in a physical, real-world space). The target object 41 may be an animated object, such as an animated character, and the visual change of the target object may include animation (e.g., movement) of the target object and/or adjustment of an appearance (e.g., color, size) of the target object, for example.

As described herein, the controller 18 may also use data from the one or more sensors 16 to adjust one or more parameters associated with the user 12. For example, the controller 18 may determine, based on the determined target point, an adjustment to a height parameter of the user 12 (e.g., which is indicative of reach of the user 12). As used herein, reach may be understood to mean a range (e.g., spherical range) within which a user is expected to be able to move or position an interactive object. As may be appreciated, reach of a user may be affected by and/or determined based on a height of the user, a shoulder height of the user, a distance between the shoulders and hands of the user, or other suitable dimensions of the user. For example, a taller user may have higher shoulders and longer arms, and may thus have a higher and larger reach, and a shorter user may have a smaller and lower reach. The reach and/or height of the user 12 may be impactful in determining a target point of the interactive object 20, as described herein. Accordingly, the adjustment to the height parameter and/or calculated reach of the user 12 may be used in determining subsequent target points determined for the interactive object 20 held by the user 12.

In an embodiment, the controller 18 may send a targeted signal or instruction (e.g., a personalized special effect signal) to the communication circuitry 26 of the interactive object 20 based on the linkage of the user 12 to the interactive object 20. Moreover, the controller 18 may update the user profile (e.g., stored in the memory 42) based on the interactions of the user 12 within the interactive environment 14. This targeted instruction or signal sent by the controller 18 may be processed by an object controller 39 housed in the interactive object 20. The object controller 39 may activate the special effect system 52, which is powered either passively (e.g., via power harvesting) or actively (e.g., by a power source) to emit a special effect that is personalized to the user's profile and/or to the interactive object 20 (e.g., each interactive object of multiple interactive objects in the interactive environment 14 may be separately addressed and/or may emit a personalized and/or unique special effect). Such a unique activation of the special effect from the interactive object 20 may facilitate confirmation of the identity of the user and/or the interactive object 20 because it may be the only interactive object that provides the special effect among a group of interactive objects. For example, the special effect may include light (e.g., visible light) emitted by one or more emitters 30 to alert the user 12 that the interactive object 20 has been detected by the one or more sensors 16 and has been separately recognized/addressed by the controller 18. Further, special effects in the interactive environment 14 based on actions (e.g., gestures) performed by the interactive object 20 may be specialized based on the linkage to the user 12 (e.g., themed in accordance with a theme preference designated in the user profile). The user profile may also include a height parameter of the user 12 that may be determined and/or adjusted by the controller 18. In an embodiment, the user 12 may view, input, and/or adjust the height parameter into the user profile.

Additionally, the communication circuitry 26 may include an RFID tag that transmits a wireless signal that communicates object identification information. The one or more sensors 16 may receive the object identification information and transmit the object identification information to the controller 18. The object identification information may then be utilized by the processor 40 of the controller 18. Specifically, for example, the controller 18 may link a user profile to the interactive object 20 based on the object identification information. The user profile may include information associated with the user 12, such as a previously determined height of the user 12. It should be appreciated that the object identification information may be communicated to the controller 18 in other ways, such as via the light (e.g., visible light, IR light) emitted by the one or more emitters 30 of the interactive object 20 (e.g., modulated light; encoded with the object identification information).

The controller 18 that drives the one or more emitters 28 and that receives and processes data from the one or more sensors 16 may include the one or more processors 40 and the memory 42. In an embodiment, the controller 18 may form at least a portion of a control system to coordinate operations of various amusement park features, such as an amusement park attraction and the interactive tracking and calibration system 10. It should be understood that the subsystems of the interactive tracking and calibration system 10 may also include similar features. In one example, the special effect system 52 may include processing capability via the processor 48 and the memory 50. Further, the object controller 39, may also include integral processing and memory components (which may be considered part of the processing circuitry and the processing system, as described herein). Alternatively, the controller 18 may control components of the interactive object 20. The processors 40, 48 may generally be referred to as “processing circuitry” herein, and the processors 40, 48 and the memories 42, 50 together may be generally referred to as “processing system” herein. By way of a specific but non-limiting example, the one or more processors 40, 48 may include one or more application specific integrated circuits (ASICs), one or more field programmable gate arrays (FPGAs), one or more general purpose processors, or any combination thereof. Additionally, the one or more memories 42, 50 may include volatile memory, such as random access memory (RAM), and/or non-volatile memory, such as read-only memory (ROM), optical drives, hard disc drives, or solid-state drives.

The controller 18 may be part of a distributed decentralized network of one or more controllers 18. The decentralized network of the one or more controllers 18 may communicate with a park central controller and park central server. The decentralized network of the one or more controllers 18 may facilitate reduction in processing time and processing power required for the one or more controllers 18 dispersed throughout one or more interactive environments 14. The decentralized network of the one or more controllers 18 may be configured to obtain user profiles by requesting the user profiles from a profile feed stored in the park central server. The user profile feed may include user heights (e.g., representative of reaches), user accomplishments associated with the interactive object, user experience level, past user locations, preferences, and other user information. The one or more controllers 18 may act as edge controllers that subscribe to a profile feed including multiple user profiles stored in a park central server and cache the feed to receive one or more user profiles contained in the feed.

The controller 18 may include one or more controllers within the interactive environment 14, and the one or more controllers may communicate with each other through the use of a wireless mesh network (WMN) or other wireless and/or wired communication methods. The special effect commands may be generated by the controller 18, a distributed node of the controller 18, or by a dedicated local controller associated with the interactive environment 14 and communicated to the interactive object 20.

The interactive object 20 may include a power source 56, which may be a battery or a power-harvester, such as a radio frequency based power-harvesting antenna or an optical harvester. The power source 56, such as the harvested power, is used to power one or more functions of the interactive object 20, such as the special effect system 52. For example, the power source 56 may power the one or more emitters 30 on the interactive object 20.

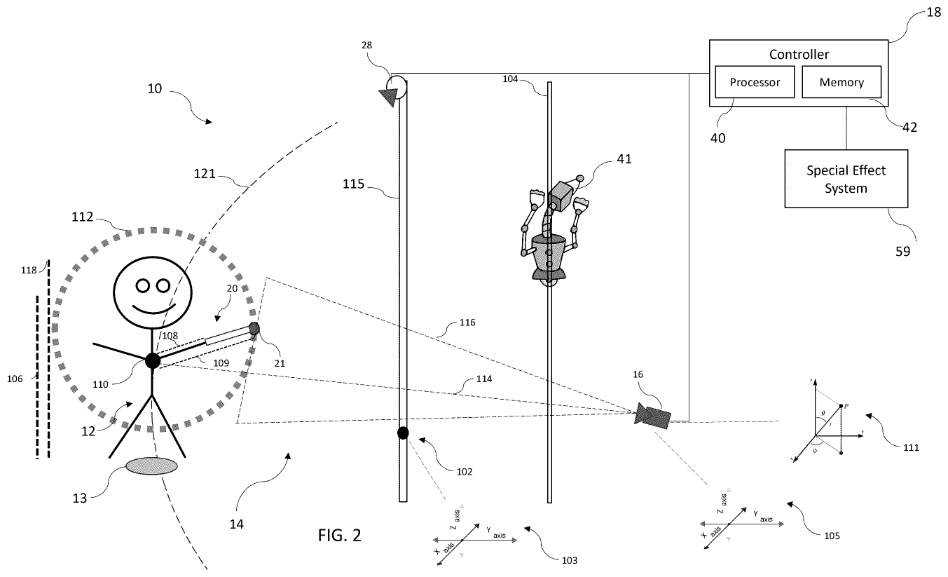

FIG. 2 is an illustration of the interactive object tracking and calibration system 10, in which known (e.g., measured, calculated, estimated) parameters of the interactive environment 14 are defined to facilitate determination of a target point during interactive experiences. The known parameters may include an origin point 102 of the interactive environment 14. The origin point 102 may be defined as a central, static location that may be used as a reference to other components of the interactive environment 14 and/or the interactive object tracking and calibration system 10 in the calculations described herein. In the illustrated example, the origin point 102 is defined at a lower central portion of the window 115 as a point in a rectangular coordinate system 103 as (X_{FO}, Y_{FO}, Z_{FO})=(0, 0, 0).

The known parameters may also include a calibrated streaming plane 104 that may be referenced to determine the target point and whether adjustments based on the determined target point may be made. The calibrated streaming plane 104 may be defined to include, for example, the target object 41, and may be positioned behind the window 115 from a viewpoint of the user 12. Further, the calibrated streaming plane 104 may include a top left corner with coordinates X_{TL}, Y_{TL}, Z_{TL} and a bottom right corner with coordinates X_{BR}, Z_{BR} (e.g., from a perspective of the user 12; such that the Y dimension of the plane is the same throughout). Additionally, to center the calibrated streaming plane 104 on the center of the window 115, a normalized streaming plane may be calculated based on a calibrated streaming plane ratio defined as:

$$Cal Ratio = \frac{{Pixels}_{Y}}{P i x e l {s}_{X}} , \qquad [ 1 ]$$

where Pixels_{Y} and Pixels_{X} are dimensions, in pixels, of the calibrated streaming plane 104. In an embodiment, the adjustment streaming plane ratio is defined such that it fills the window 115 or exceeds the window in the X or Z direction. If the calibrated streaming plane ratio satisfies

$$Cal Ratio > \frac{{X}_{B R} - {X}_{T L}}{{Z}_{T L} - {Z}_{B R}} , \qquad [ 2 ]$$

then coordinates of the normalized calibrated streaming plane may be determined as:

$${X}_{TLN} = {X}_{TL} , \qquad [ 3 ]$$

$${X}_{BRN} = {X}_{BR} , \qquad [ 4 ]$$

$${Y}_{TLN} = {Y}_{TL} , \qquad [ 5 ]$$

$${Z}_{TLN} = \frac{{Z}_{TL} + {Z}_{BR}}{2} + \frac{{X}_{BR} - {X}_{TL}}{2 * Cal Ratio} , \qquad [ 6 ]$$

$${Z}_{BRN} = \frac{{Z}_{TL} + {Z}_{BR}}{2} - \frac{{X}_{BR} - {X}_{TL}}{2 * Cal Ratio} , \qquad [ 7 ]$$

and
where X_{TLN}, Y_{TLN} are coordinates of the top left of the normalized calibrated streaming plane (e.g., from the perspective of the user 12), and X_{BRN}, Z_{BRN} are coordinates of the bottom right of the normalized calibrated streaming plane (e.g., from the perspective of the user 12). If, however, equation 1 is not satisfied, coordinates of the normalized calibrated streaming plane may be determined as:

$${X}_{TLN} = \frac{{X}_{BR} + {X}_{TL}}{2} + \frac{{Z}_{BR} - {Z}_{TL}}{2 * Cal Ratio} , \qquad [ 8 ]$$

$${X}_{BRN} = \frac{{X}_{BR} + {X}_{TL}}{2} + \frac{{Z}_{BR} - {Z}_{TL}}{2 * Cal Ratio} , \qquad [ 9 ]$$

$$and$$

$${Y}_{T L N} = {Y}_{T L} \qquad [ 10 ]$$

$${Z}_{T L N} = {Z}_{T L} \qquad [ 11 ]$$

$${Z}_{B R N} = {Z}_{B R} . \qquad [ 12 ]$$

Additionally, the known parameters may include parameters that define a location of the user 12. For example, the location of the user 12 may include a defined location of the marker 13, a user-height parameter 106 of the user 12, a defined interactive object length of the interactive object 20, and an arm length 108 calculated based on the user-height parameter 106. For example, the marker 13 may be defined, with reference to the origin point 102, as (X_{M}, Y_{M}, Z_{M}=0, −3, −2). The user-height parameter 106, also referred to herein as an adjustable user-height parameter, may be adjusted to approximate an actual height of a user, and may be defined initially as a minimum expected value of heights of users (e.g., 4 feet, or about 1.2 meters), as described herein. The user-height parameter 106 may initially correspond to a minimum height of an amusement ride or as a percentile of heights of guests at an amusement park, as examples. The arm length 108 may be calculated as, for example, a fraction of the user-height parameter 106 (e.g., four tenths of the user-height parameter 106).

The parameters that define the location of the user 12 may also include a shoulder location 110, which may be calculated based on the user-height parameter 106. It should be appreciated that the shoulder location 110 is shown in a simplified manner to facilitate discussion and image clarity; however, the shoulder location 110 may be intended to represent and/or be at or proximate to a shoulder joint of an arm that is holding the interactive object 20 (e.g., represent and/or be at or proximate to a right shoulder joint, a left shoulder joint, an upper end of a right arm, an upper end of a left arm, and/or an upper body portion of the user 12). For example, the shoulder location 110 may be calculated in the rectangular coordinate system 103 as:

$${X}_{S} , {Y}_{S} , {Z}_{S} , = ( {X}_{M} , {Y}_{M} , {Z}_{M} + \frac{7}{8} * guestHeight ) . \qquad [ 13 ]$$

In addition, the parameters that define the location of the user 12 may include a reach 112 of the user 12 which, as mentioned, may include a spherical range of expected locations of the detectable marker 21 of the interactive object 20 held by the user 12 (e.g., having the user-height parameter 106 and corresponding values of the arm length 108 and the shoulder location 110). A radius 109 of this sphere, centered at the shoulder location 110, may be calculated as:

$${L}_{SW} = objectlength + armlength , \qquad [ 14 ]$$

where objectLength is the length of the interactive object 20 and armlength is the length 108 of the arm of the user 12.

The known parameters may also include a sensor location of the one of the one or more sensors 16 (referred to herein as “the camera 16” to facilitate discussion), which may be defined in the rectangular coordinate system 103 as X_{C}, Y_{C}, Z_{C}. Based on the camera location and the shoulder location 110, a camera-to-shoulder length 114 may be calculated as:

$${L}_{CS} = \sqrt{{( {X}_{S} - {X}_{C} )}^{2} + {( {Y}_{S} - {Y}_{C} )}^{2} + {( {Z}_{S} - {Z}_{C} )}^{2}} . \qquad [ 15 ]$$

The known parameters may then be normalized relative to the location of the camera 16 as a rectangular coordinate system 105. For example, the camera location at a camera origin in the rectangular coordinate system 105 may be defined as (X_{C@C}, Y_{C@C}, Z_{C@C})=(0, 0, 0). The shoulder location 110 may then be translated to the rectangular coordinate system as:

$$( {X}_{S @ C} , {Y}_{S @ C} , {Z}_{S @ C} ) = ( {X}_{S} - {X}_{C} , {Y}_{S} - {Y}_{C} , {Z}_{S} - {Z}_{C} ) . \qquad [ 16 ]$$

These known parameters may also be converted to a polar coordinate system 111 with an origin at the location of the camera 16. Further, the shoulder location 110 may be converted to the polar coordinate system 111 as:

$${ρ}_{SPol @ C} , {θ}_{SPol @ C} , {∅}_{SPol @ C} = ( {L}_{CS} , {cos}^{- 1} ( \frac{{Z}_{S @ C}}{{L}_{C S}} ) , - [ {cos}^{- 1} ( \frac{{x}_{S @ C}}{\sqrt{{X}_{S @ C}^{2} + {Y}_{S @ C}^{2}}} ) ] , \qquad [ 17 ]$$

where L_{CS} is the camera-to-shoulder length 114 and X_{S@C}, Y_{S@C}, and Z_{S@C} are coordinates of the shoulder location 110 with respect to the location of the camera 16 as the origin. Additionally, an angular field of view 116 of the camera 16 may be defined as (λC, ψC), a pixel resolution of the camera 16 may be defined as (PX_{C}, PZ_{C}), and the shoulder location 110 in a frustrum of the field of view of the camera 16 may be defined as (PX_{S}, PZ_{S}). Further, the angular location of the shoulder location 110 in the frustrum of the field of view of the camera 16 may be calculated as:

$$( {𝒳}_{S} , {ψ}_{S} ) = ( P {X}_{S} * {χ}_{C} / {PX}_{C} , {PZ}_{S} * {ψ}_{C} / {PZ}_{C} ) . \qquad [ 18 ]$$

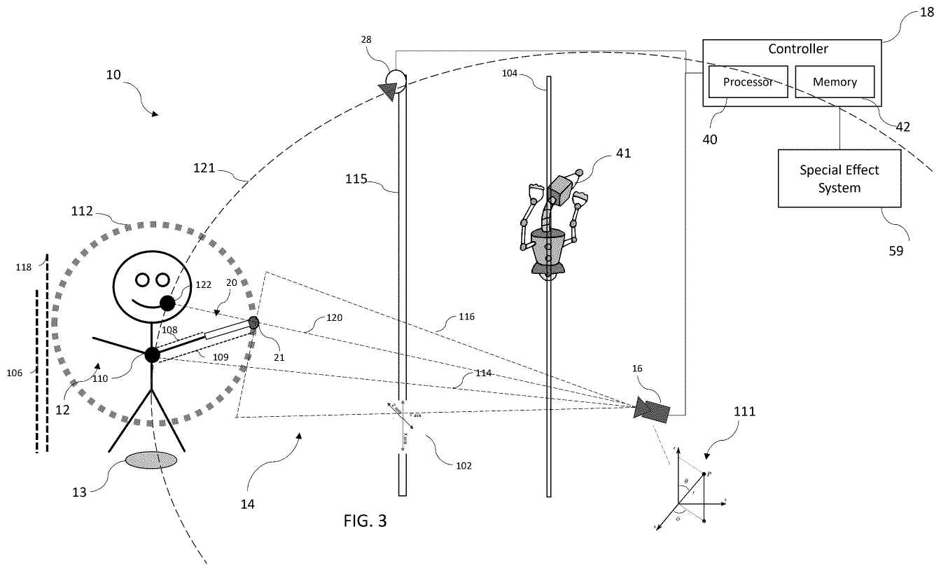

FIG. 2 illustrates certain parameters that may be used to determine the target point during interactive experiences, as described in more detail with reference to FIGS. 3-5.

FIG. 3 is an illustration of the interactive object tracking and calibration system 10 in which the location of the detectable marker 21 of the interactive object 20 is determined. As mentioned, the camera 16 may receive, as input, light reflected from the detectable marker 21 as the interactive object 20 is moved by the user 12. This light may be defined in the frustrum of the camera 16 as (PX_{W}, PZ_{W}), which may include, for example, an illuminated pixel of a matrix of pixels detectable by the camera 16. The angular location of the detectable marker 21 in the frustrum of the camera 16 may be calculated as:

$$( {χ}_{W} , {ψ}_{W} ) = ( {PX}_{W} / {PX}_{C} * {χ}_{C} , {PZ}_{W} / {PZ}_{C} * {ψ}_{C} ) . \qquad [ 19 ]$$

Additionally, a line 120 from the camera 16 through the detectable marker 21 may be defined. The coordinates of the line 120 may be defined parametrically in terms of a common variable such that when the common variable is equal to zero, the coordinates correspond to the location of the camera 16, and when the common variable is equal to one, the coordinates correspond to a point 122. With this in mind, a point 122 along the line 120 at a radial distance 121 equal to the camera-to-shoulder length 114 may be calculated in the polar coordinate system 111 as:

$$( {ρ}_{D} , {Θ}_{D} , {φ}_{D} ) = ( {ρ}_{SPol @ C} , {Θ}_{SPol @ C} + {ψ}_{S} - {ψ}_{W} , {φ}_{SPol @ C} - {χ}_{S} + {χ}_{W} ) , \qquad [ 20 ]$$

and in the rectangular coordinate system 105 as:

$$( {X}_{D} , {Y}_{D} , {Z}_{D} ) = ( {ρ}_{D} * sin ( {Θ}_{D} ) * cos ( {φ}_{D} ) , {ρ}_{D} * sin ( {Θ}_{D} ) * sin ( {φ}_{D} ) , {ρ}_{D} * cos ( {Θ}_{D} ) ) . \qquad [ 21 ]$$

Additionally, a parametric representation of the line 120 from the camera 16 to the point 122 may be given as:

$${X}_{C D} = t * {X}_{D} , \qquad [ 22 ]$$

$${Y}_{C D} = t * {Y}_{D} , and \qquad [ 23 ]$$

$${Z}_{C D} = t * {Z}_{D} , \qquad [ 24 ]$$

where t is a common variable of the line 120.

Moving on, to find the position of the detectable marker 21, the reach 112 and the line 120 are evaluated for an intersection point in which the common variable t is between one and zero. This intersection point may define the position of the detectable marker 21 in the rectangular coordinate system 105. As described herein, the reach 112 may be calculated as a sphere centered at the shoulder location 110 with a radius equal to a sum of the arm length 108 and the length of the interactive object 20. In rectangular coordinates, the intersection point may be calculated based on the common variable t, which may be determined as:

$${( {X}_{D} t - {X}_{S @ C} )}^{2} + {( {Y}_{D} t - {Y}_{S @ C} )}^{2} + {( {Z}_{D} t - {Z}_{S @ C} )}^{2} = {L}_{SW}^{2} , or \qquad [ 25 ]$$

$$t = \frac{- b \pm \sqrt{{b}^{2} - 4 ac}}{2 a} , \qquad [ 26 ]$$

$$where$$

$$a = {X}_{D}^{2} + {Y}_{D}^{2} + {Z}_{D}^{2} , \qquad [ 27 ]$$

$$b = - 2 * ( {X}_{D} {X}_{S @ C} + {Y}_{D} {Y}_{S @ C} + {Z}_{D} {Z}_{S @ C} ) , and \qquad [ 28 ]$$

$$c = ( {X}_{S @ C}^{2} + {Y}_{S @ C}^{2} + {Z}_{S @ C}^{2} - {L}_{SW}^{2} ) . \qquad [ 29 ]$$

Further, the intersection point, and thus the location of the detectable marker 21, may be calculated in rectangular coordinates as:

$$( {X}_{W @ C} , {Y}_{W @ C} , {Z}_{W @ C} ) = ( t * {X}_{D} , t * {Y}_{D} , t * {Z}_{D} ) \qquad [ 30 ]$$

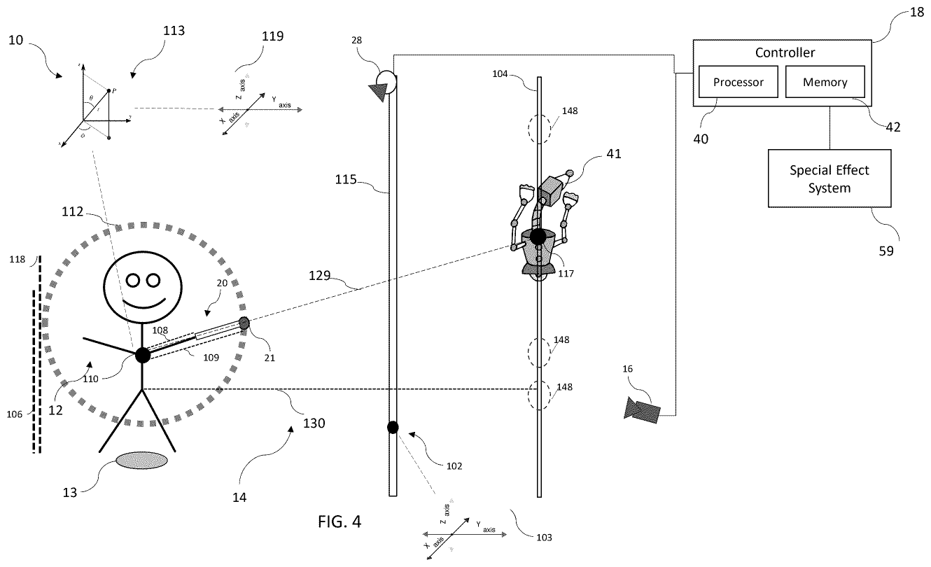

FIG. 4 is an illustration of the interactive object tracking and calibration system 10 in which a target point 117 of the interactive object 20 on the calibrated streaming plane 104 is determined. A polar coordinate system 113 may be defined with an origin (X_{S@S}, Y_{S@S}, Z_{S@S})=(0, 0, 0) at the shoulder location 110, and the location of the detectable marker 21 may be calculated in the polar coordinate system 113. The location of the detectable marker 21 within the polar coordinate system 113 may be given in a corresponding rectangular coordinate system 119 by:

$$( {X}_{W @ S} , {Y}_{W @ S} , {Z}_{W @ S} ) = ( {X}_{W @ C} - {X}_{S @ C} , {Y}_{W @ C} - {Y}_{S @ C} , {Z}_{W @ C} - {Z}_{S @ C} ) , \qquad [ 31 ]$$

and the location of the detectable marker 21 within the polar coordinate system 113 may be given in polar coordinates by:

$$( {ρ}_{WPol @ S} , {Θ}_{WPol @ S} , {φ}_{WPol @ S} ) = ( {L}_{SW} , {cos}^{- 1} ( {Z}_{W @ S} / {L}_{SW} ) , [ {cos}^{- 1} ( {X}_{W @ S} / √ ( {X}_{W @ S}^{2} + {Y}_{W @ S}^{2} ) ) ] . \qquad [ 32 ]$$

Additionally, the shoulder location 110 is known, and thus a distance 130 between the shoulder location 110 and the calibrated streaming plane 104 in the Y (e.g., lateral) direction of the rectangular coordinate system 119 may be determined as:

$${L}_{FS} = {Y}_{F} - {Y}_{S} , \qquad [ 33 ]$$

where Y_{F} is the Y distance between the origin point 102 and the calibrated streaming plane 104, and Y_{S} is the Y distance between the origin point 102 and the shoulder location 110. The distance 129 from the shoulder location 110, through the detectable marker 21, to the calibrated streaming plane 104 may be defined in terms of (φ, Θ) relative to the location of the detectable marker 21 in the polar coordinate system 113. This point of intersection may be defined as the target point 117. For example, the shoulder location 110 in polar coordinates at an angle of the detectable marker 21 at the distance 130 may be determined as:

$$( {ρ}_{FPol @ S} , {Θ}_{FPol @ S} , {φ}_{FPol @ S} ) = ( {L}_{FS} / sin ( {Θ}_{WPol @ S} ) * sin ( {φ}_{WPol @ S} ) , {L}_{FS} / sin ( {Θ}_{WPol @ S} ) * sin ( {φ}_{WPol @ S} ) , {Θ}_{WPol @ S} , {φ}_{WPol @ S} ) \qquad [ 34 ]$$

Finally, the location of the target point 117 relative to the shoulder location 110 may be given in the rectangular coordinate system 119 as:

$$( {X}_{F @ S} , {Y}_{F @ S} , {Z}_{F @ S} ) = ( {ρ}_{FPol @ S} * sin ( {Θ}_{FPol @ S} ) * cos ( {φ}_{FPol @ S} ) , {ρ}_{FPol @ S} * sin ( {Θ}_{FPol @ S} ) * sin ( {φ}_{FPol @ S} ) , {ρ}_{FPol @ S} * cos ( {Θ}_{WPol @ C} ) ) . \qquad [ 35 ]$$

Additionally, the target point 117 relative to the origin point 102 (e.g., the original, cartesian origin point) of the interactive environment 14 may be defined in the rectangular coordinate system 103 by:

$$( {X}_{F} , {Y}_{F} , {Z}_{F} ) = ( {X}_{F @ S} + {X}_{S} , {Y}_{F @ S} + {Y}_{S} , {Z}_{F @ S} + {Z}_{S} ) . \qquad [ 36 ]$$

Thus, in FIGS. 3 and 4, the parameters established as described with respect to FIG. 2 are utilized to determine the target point 117 of the interactive object 20. The parameters include the user-height parameter 106 and associated parameters, such as the shoulder location 110 and the reach 112. Further, the parameters may initially be estimated or assumed to be a first set of values, such as a first or initial user height (e.g., 4 feet or about 1.2 meters) with associated shoulder location and reach. The target point 117 may be indicative of or represent a desired interaction point of the user 12. For example, in FIG. 4, the target point 117 corresponds to the target object 41 and may be considered to indicate that the user 12 would like to interact with (e.g., select, actuate; cause special effects for) the target object 41. It should be appreciated that additional target objects 148 may be available (e.g., displayed; visible to the user 12 through the window 115; shown in dashed lines in FIG. 4 to facilitate discussion), and thus the target point 117 indicates that the user 12 would like to interact with the target object 41 instead of the additional target objects 148 (e.g., the controller 18 should instruct response from the target object 41 among all available target objects).

As described herein, the parameters may be updated from the first set of values to a second set of values (e.g., a second user height greater than the first or initial user height), such as in response to determining that using the first set of values to determine the target point 117 results in the target point 117 being outside of an expected range or area (e.g., outside of the calibrated streaming plane 104). It may be appropriate to update the parameters from the first set of values to the second set of values in such cases, as it is unlikely that the user 12 is aiming the interactive object 20 outside of the expected range or area, and thus it is likely that an actual height of the user 12 exceeds the first or initial user height. Accordingly, the update to the parameters from the first set of values to the second set of values will facilitate or allow more accurate determination of the target point 117 when the interactive object 20 held by the user 12. Further, should use of the second set of values result in the target point 117 being outside of the expected range or area, the parameters may be updated again to a third set of values (e.g., a third user height greater than the second user height) and possibly additional times until the target point 117 is within the expected range or area. In this way, the user-height parameter 106 may utilized as an assumption (e.g., estimation) of an actual height 118 of the user 12 to determine the target point 117 with limited information (e.g., with one point of light reflected by the detectable marker 21 and detected by the camera 16).

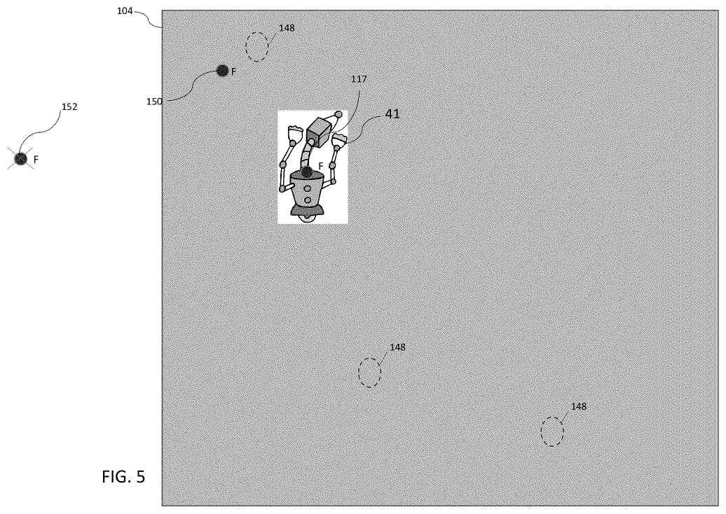

FIG. 5 is an illustration of the calibrated streaming plane 104 including the determined target point 117. As illustrated, FIG. 5 also includes target points 150 and 152, which may each be determined using the techniques described herein. In an embodiment, the target point 117 may correspond to the target object 41 within the calibrated streaming plane 104. The target point 117 and the target point 150 may each correspond to a location of the detectable marker 21 (FIGS. 1-4) of the interactive object 20 (FIGS. 1-4) within an expected reach (e.g., the reach 112 of FIGS. 2-4) of the user 12 (FIGS. 1-4), which, as discussed, may be associated with an expected or assumed height of the user 12 (e.g., the user-height parameter 106 of FIGS. 2-4). The target point 152, however, is outside of the calibrated streaming plane 104, and may correspond to a location of the detectable marker 21 of the interactive object 20 that is outside the expected reach (e.g., the reach 112) of the user 12. For example, the target point 152 may be the result of the user 12 having an actual height that is not proximate to the user-height parameter 106 used in the calculations herein and/or an actual reach that is not proximate to the reach 112 used in the calculations herein. As such, the controller 18 may adjust (e.g., increase) the user-height parameter 106 parameter of the user 12 in response to determining that the target point 152 is outside the calibrated streaming plane 104.

The location of the target point may be communicated to the controller 18. To facilitate that communication, the location of the target point 117 may be known relative to the extents of the normalized calibrated streaming plane 104 in the rectangular coordinate system 103 by:

$${X}_{STREAM} = ( {X}_{{F}^{-}} {X}_{T L N} ) / ( {X}_{B R N} - {X}_{T L N} ) , \qquad [ 37 ]$$

$$and$$

$${Z}_{STREAM} = ( {Z}_{{F}^{-}} {Z}_{T L N} ) / ( {Z}_{B R N -} {Z}_{TLN} ) . \qquad [ 38 ]$$

The result may be a stream that is normalized to 0-1.0 or other scale that is common across multiple embodiments.

As shown for reference in FIG. 5, the additional target objects 148 may be presented with the target object 41. The target point 117 corresponds to (e.g., overlaps or is aligned with; is closest to in the calibrated streaming plane 104) the target object 41 and may indicate that the user 12 would like to interact with the target object 41 instead of the additional target objects 148 (e.g., the controller 18 should instruct response from the target object 41 among all available target objects). Further, the target point 150 corresponds to one of the additional target objects 148 and may indicate that the user 12 would like to interact with the one of the additional target objects 148 instead of other ones of the additional target objects 148 or the target object 41 (e.g., the controller 18 should instruct response from the one of the additional target objects 148 among all available target objects). As described herein, the target point 152 may not cause any response from the available target objects, but instead may trigger an update to the user-height parameter 106 and recalculation of the target point 152 using the updated user-height parameter 106.

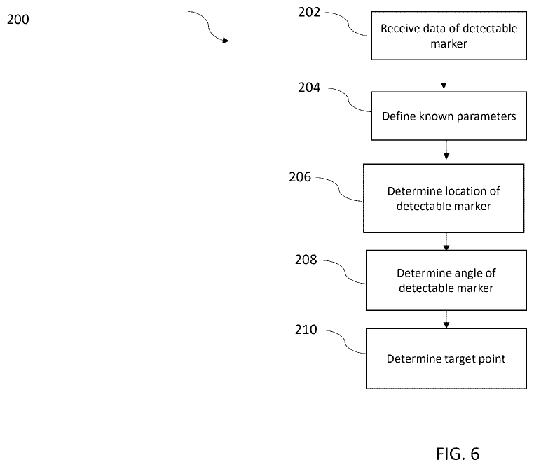

FIG. 6 is a flow diagram of a method 200 for determining a target point of an interactive object, in accordance with present techniques. To facilitate discussion, the method 200 is described with reference to certain features shown in FIGS. 1-5. In block 202, the controller 18 may receive data corresponding to the detectable marker 21 of the interactive object 20 via the one or more sensors 16 (e.g., the camera 16). As mentioned, the data may include image data including a point, pixel, or the like corresponding to the detectable marker 21 within the field of view of the camera 16. In block 204, the controller 18 may define known or assumed parameters associated with the user 12 and the interactive environment 14. For example, the known parameters may include an origin point 102 of the interactive environment 14 that may be used as a reference to other components. The known parameters may also include the calibrated streaming plane 104 that may be referenced to determine whether adjustments based on a determined target point 117 may be made. The calibrated streaming plane 104 may be defined to include, for example, the target object 41, and may be defined behind the window 115 from a viewpoint of the user 12. Additionally, to center the calibrated streaming plane 104 on the center of the window 115, a normalized streaming plane may be determined by the controller 18 based on a calibrated streaming plane ratio defined as according to equation 1.

Additionally, the known or assumed parameters may include parameters that define a location of the user 12. For example, the location of the user 12 may include a defined location of the marker 13, a defined user-height parameter 106 of the user 12, a defined interactive object length of the interactive object 20, and the arm length 108 calculated by the controller 18 based on the user-height parameter 106 The user-height parameter 106 may be defined, at least initially, as a minimum expected value of heights of guests (e.g., 4 feet or about 1.2 meters). The parameters that define the location of the user 12 may also include the shoulder location 110, which may be calculated based on the user-height parameter 106. For example, the shoulder location 110 may be calculated by the controller 18 according to equation 13. In addition, the parameters that define the location of the user 12 may include the reach 112 of the user 12 which, as mentioned, may include a spherical range of expected locations of the detectable marker 21 of the interactive object 20. The radius 109 of this sphere, centered at the shoulder location 110, may be calculated by the controller 18 according to equation 14.

The known parameters may also include a location of the camera 16. Based on the camera location and the shoulder location 110, a camera-to-shoulder length 114 may be calculated by the controller 18 according to equation 15. The known parameters may then be normalized relative to the location of the camera 16. For example, the camera location at a camera origin may be defined as (X_{C@C}, Y_{C@C}, Z_{C@C})=(0, 0, 0). The shoulder location 110 may then be translated to a rectangular coordinate system located at the camera according to equation 16. These known parameters may also be converted to a polar coordinate system 111 with an origin at the location of the camera 16. For example, the shoulder location 110 may be converted to the polar coordinate system at the camera origin according to equation 17. Additionally, an angular field of view 116 of the camera 16 may be defined as (χC, ψC), a pixel resolution of the camera 16 may be defined as (PX_{C}, PZ_{C}), and the shoulder location 110 in a frustrum of the field of view of the camera 16 may be defined as (PX_{S}, PZ_{S}). Further, the angular location of the shoulder location 110 in the frustrum of the field of view of the camera 16 may be calculated by the controller 18 according to equation 18.

In block 206, the location of the detectable marker 21 of the interactive object 20 may be determined. As mentioned, the camera 16 may receive, as input, light reflected from the detectable marker 21 as the interactive object 20 is moved by the user 12. This light may be defined in the frustrum of the camera 16 as (PX_{W}, PZ_{W}), which may include, for example, an illuminated pixel of a matrix of pixels. The angular location of the detectable marker 21 in the frustrum of the camera 16 may be calculated by the controller 18 according to equation 19.

Additionally, the line 120 from the sensor 16 through the detectable marker 21 may be defined. The coordinates of the line 120 may be defined parametrically in terms of a common variable such that when the common variable is zero, the coordinates correspond to the location of the camera 16, and when the common variable is one, the coordinates correspond to the point 122. With this in mind, the point 122 along the line 120 at a radius equal to the camera-to-shoulder length 114 may be calculated in a polar coordinate system according to equation 20 and in a rectangular coordinate system according to equation 21. Additionally, a parametric representation of the line 120 from the camera 16 to the point 122 may be determined by the controller 18 according to equations 22, 23, and 24.

To find the position of the detectable marker 21, the reach 112 and the line 120 may be evaluated for an intersection point in which the common variable t is between one and zero. This intersection point may define the position of the detectable marker 21 in the rectangular coordinate system. As described herein, the reach 112 may be calculated as a sphere centered at the shoulder location 110 with a radius equal to a sum of the arm length 108 and the length of the interactive object 20. In rectangular coordinates, the intersection point may be calculated by the controller 18 based on the common variable t, which may be determined using equations 25-29. Further, the intersection point, and thus the location of the detectable marker 21, may be calculated by the controller 18 in rectangular coordinates according to equation 30.

In block 208, the angle of the detectable marker 21 relative to the shoulder location 110 may be determined by the controller 18. This angle may characterize an angle with which the user 12 is pointing the interactive object 20 and, by finding the intersection of this angle and the calibrated streaming plane 104, the target point 117 may be determined. As discussed, a polar coordinate system 113 may be defined with an origin (X_{S@S}, Y_{S@S}, Z_{S@S})=(0, 0, 0) at the shoulder location 110 with the same X, Y, and Z orientation of FIG. 3, and the location of the detectable marker 21 may be calculated in the polar coordinate system 113. The location of the detectable marker 21 within the polar coordinate system 113 may be converted to the rectangular coordinate system 119 by the controller 18 according to equation 31. Further, the location of the detectable marker 21 within the polar coordinate system 113 may be calculated by the controller 18 according to equation 32.

In block 210, the target point 117 in the calibrated streaming plane 104 may be determined by the controller 18 according to the techniques described herein. For example, the distance 130 between the shoulder location 110 and the calibrated streaming plane 104 in the Y direction may be calculated by the controller according to equation 33. This distance 130 may be defined in terms of (φ, Θ) relative to the location of the detectable marker 21 in the polar coordinate system 113. For example, the shoulder location 110 in polar coordinates at the angle of the detectable marker 21 at the distance 130 may be calculated by the controller 18 according to equations 34-36. Finally, the location of the target point 117 in the rectangular coordinate system 113 may be calculated by the controller 18 according to equation 37. Additionally, the target point 117 relative to the origin point 102 (e.g., the original, cartesian origin point) of the interactive environment 14 may be determined using equation 38. The location of the target point 117 relative to the extents of the calibrated streaming plane 104 may be calculated by the controller 18 according to equations 37 and 38.

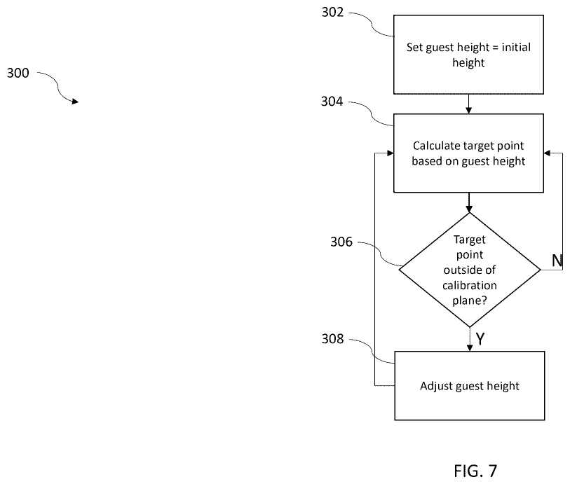

FIG. 7 is a flow diagram of a method 300 for calibrating an interactive object tracking and calibration system 10, in accordance with present techniques. In block 302, the controller 18 may set the user-height parameter 106 as an initial value. The initial value may correspond to a minimum height, average height, percentile (e.g., 10^{th} percentile of heights of measured guests) or other suitable initial height. For example, an initial height may be 1 meter, 1.2 meters, 4 feet and 4 inches, or the like, and may correspond to a minimum height with which a user can easily observe target objects through the window 115 of the interactive environment 14.

In block 304, the controller 18 may determine a target point (e.g., the target point 117) in the calibrated streaming plane 104 based on the user-height parameter 106 and other parameters and inputs, such as input from the camera 16. The controller 18 may perform block 304 by performing some or all of blocks 202, 204, 206, 208, and 210 of the method 200, for instance. As discussed herein, the determined target point may be based on the user-height parameter 106. For example, the shoulder location 110 may be determined based on the user-height parameter 106, as described in equation 13. Other known parameters such as the arm length 108 of the user 12 may be calculated as a fraction of the user-height parameter 106 (e.g., four tenths of the user-height parameter 106), and the reach 112 of the user 12, centered at the shoulder location 110, may be calculated according to equation 14 based on the arm length 108. As such, adjustments to the user-height parameter 106 may cause changes in associated parameters and, accordingly, changes in the determined target point for a particular location of the detectable marker 21 of the interactive object 20 as detected by the camera 16.

In block 306, the controller 18 determines whether the determined target point is outside of the calibrated streaming plane 104. As illustrated in FIG. 5, a determined target point may be within the extents of the calibrated streaming plane 104 (e.g., the target points 117 and 150) or outside the extents of the calibrated streaming plane 104 (e.g., the target point 152). The controller 18 may determine whether the determined target point is outside the calibrated streaming plane 104 based on, for example, the equations 37 and 38. In one example, the controller 18 may determine that the determined target point is outside the calibrated streaming plane 104 in response to either of the X_{STREAM} or Y_{STREAM} coordinates being negative, exceeding a threshold value, or the like.

If the determined target point is not outside the calibrated streaming plane 104, the controller 18 may return to block 304 to calculate a subsequent target point. This may indicate that the user-height parameter 106 is properly calibrated or set for the user 12. For example, the controller 18 may receive new input via the camera 16 (e.g., reflected light from the detectable marker 21) and may calculate a subsequent target point based on the new input without adjusting the user-height parameter 106. If, however, the controller 18 determines that the determined target point is outside the calibrated streaming plane 104, in block 308, the controller 18 may adjust the user-height parameter 106. For example, the controller 18 may adjust (e.g., increase) the user-height parameter 106 parameter by a predefined increment (e.g., 3 inches, 6, inches, 1 foot). In another example, the controller 18 may adjust the user-height parameter 106 based on a distance between the calibrated streaming plane 104 and the determined target point in the X-Z plane, as determined by, for example, equations 37 and 38. This may indicate a severity or level of difference between an actual height 118 and the user-height parameter 106 that was used to determine the target point, for instance. The controller 18 may determine that the target point is proximate (e.g., within a threshold distance in the X-Z plane) to the calibrated streaming plane 104 and make a minor user height adjustment in response (e.g., 3 inches), or may determine that the target point is not proximate (e.g., outside of the threshold distance) to the calibrated streaming plane 104, and may make a more significant adjustment to the user height (e.g., 1 foot) in response, as an example.

After the user-height parameter is adjusted in block 308, the controller 18 may return to block 304 to calculate a subsequent target point based on the adjusted user-height parameter 106 and new input via the camera 16. As discussed herein, adjusting the user-height parameter 106 may cause a change in the determined target point, which may more accurately characterize an intent of the user 12 in positioning the interactive object 20. Adjusting the user-height parameter 106 may cause the interactive object tracking and calibration system 10 to determine that the target point corresponds to the target object 41.

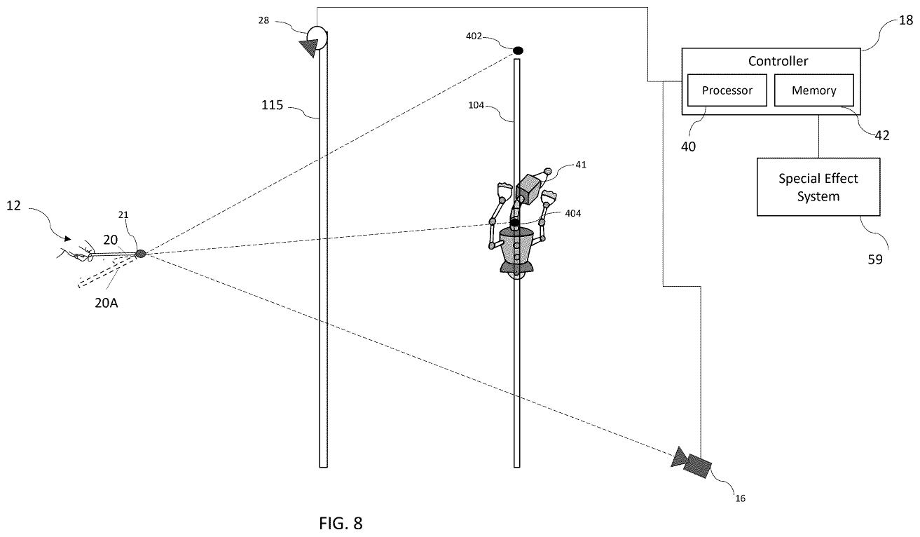

To illustrate, FIG. 8 illustrates the interactive object tracking and calibration system 10, in which the controller 18 determines two target points based on different user-height parameters 106 for the user 12. In the illustrated example, a first interactive object 20A may represent an assumed position of the interactive object 20 held by the user 12 based on, for example, an initial user-height parameter 106 (FIGS. 2-4). As illustrated, based on the initial user-height parameter 106, the controller 18 may calculate a first target point 402 according to the techniques described herein, and the first target point 402 may be outside the extents of the calibrated streaming plane 104 that may be behind the window 115. The controller 18 may, in response, adjust (e.g., increase) the user-height parameter 106, such that the user-height parameter 106 better characterizes the position of the interactive object 20 held by the user 12. As illustrated, the detectable marker 21 of the first interactive object 20A and the interactive object 20 may appear within the field of view of the camera 16 as the same input (e.g., reflected light at the same pixel). However, by adjusting the user-height parameter 106 for the user 12, the controller 18 determines an adjusted target point 404 that may, for example, more accurately reflect a desired input from the user 12 pointing the interactive object 20 towards the target object 41.

Accordingly, the interactive object tracking and calibration system described herein facilitates efficient and accurate identification of target objects and provides desired special effects to the user. It should be appreciated that the user height may be determined (e.g., adjusted) as described herein and then saved to the user profile and/or the object profile. As it is recognized that groups of users (e.g., families or friend groups) may share the interactive object, the user height may be saved to the user profile and/or the object profile only after (e.g., in response to) a threshold number of consecutive uses and adjustments that indicate consistent use of the interactive object by user(s) with a particular user height. For example, the user height may be saved to the user profile and/or the object profile only after 5, 10, or more consecutive adjustments from the initial user height to one adjusted user heights. As another example, during one use at a first window in the interactive environment, the user height may be adjusted from an initial user height to an adjusted user height that is used for a remainder of the use at the first window or for some period of time (e.g., 2, 5, 10 minutes) as long as target points remain within the extent of the calibration streaming plane. However, during another use at a second window in the interactive environment or after the period of time, the user height may be reset to the initial user height. This may balance accuracy for extended use by one user with resets to account for sharing the interactive object between users. In an embodiment, the user height may be reset and/or adjusted manually via input by the user(s) to the user profile and/or the object profile.

Advantageously, the interactive object tracking and calibration system described herein may provide immersive experiences for multiple users of varying actual heights within the interactive environment. For example, the multiple users may handle multiple interactive objects (e.g., one per user) to interact with multiple target objects visible through or at multiple windows, for example. Calibration techniques described herein may assume and use the initial user height and associated parameters to estimate the target points of the multiple target objects, and may also efficiently adjust (e.g., increase) the initial user height for certain users in response to their target points being outside of an expected area indicated by the calibration streaming plane. In this way, even single points of light (e.g., from the detectable markers) may be utilized to accurately determine the target points of the interactive objects held by the multiple users of varying actual heights.

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method, comprising:
receiving input from an interactive object held by a user in an interactive environment;
determining a target point of the interactive object based on the input and a user-height parameter of the user; and
adjusting the user-height parameter in response to the target point being outside an adjustment plane of the interactive environment.

2. The method of claim 1, wherein receiving the input from the interactive object comprises capturing image data that includes the interactive object, the image data including a pixel that corresponds to a detectable marker of the interactive object.

3. The method of claim 2, wherein determining the target point of the interactive object comprises determining a location of the detectable marker based on the input.

4. The method of claim 1, wherein determining the target point of the interactive object based on the input and the user-height parameter of the user comprises:
determining a reach of the user based on the user-height parameter of the user; and
determining the target point of the interactive object based on the input and the reach of the user.

5. The method of claim 4, comprising receiving the input from the interactive object via a sensor, wherein determining the target point of the interactive object based on the input and the reach of the user comprises:
determining a line from the sensor though the interactive object; and
determining the target point of the interactive object as an intersection point between the line and the reach of the user.

6. The method of claim 4, wherein determining the reach of the user based on the user-height parameter of the user comprises:
determining an arm length of the user based on the user-height parameter of the user;
determining a shoulder location of the user based on the user-height parameter of the user; and
determining the reach of the user based on the arm length of the user and the shoulder location of the user.

7. The method of claim 6, wherein determining the target point of the interactive object based on the input and the user-height parameter of the user comprises:
determining an angle of the interactive object relative to the shoulder location; and
determining the target point of the interactive object based on the angle.

8. The method of claim 1, comprising:
before receiving the input from the interactive object, setting the user-height parameter to an initial height.

9. The method of claim 8, wherein the initial height is less than 1.5 meters.

10. The method of claim 8, wherein adjusting the user-height parameter comprises increasing the user-height parameter from the initial height.

11. The method of claim 1, wherein the adjustment plane comprises one or more virtual objects to be interacted with by the user using the interactive object.

12. An object tracking system for an interactive environment, comprising:
an interactive object held by a user in the interactive environment;
a sensor configured to receive input indicative of the interactive object; and
a controller communicatively coupled to the sensor and configured to:
determine a target point of the interactive object based on the input and a user-height parameter of the user; and
adjust the user-height parameter based on the target point.

13. The object tracking system of claim 12, wherein the sensor comprises a camera, and wherein the input indicative of the interactive object comprises image data.

14. The object tracking system of claim 13, comprising an infrared (IR) emitter, wherein the interactive object comprises a detectable marker configured to reflect IR light emitted by the IR emitter, and wherein the camera is configured to receive the reflected IR light as the input.

15. The object tracking system of claim 12, wherein the controller is configured to adjust the user-height parameter in response to the target point being outside an adjustment plane of the interactive environment, the adjustment plane defined to include one or more virtual objects of the interactive environment.

16. The object tracking system of claim 12, wherein the controller is configured to store the adjusted user-height parameter as part of a stored user profile associated with the user.

17. The object tracking system of claim 12, wherein the controller is configured to determine the target point of the interactive object by:
determining a location of the interactive object based on the input and the user-height parameter of the user;
determining an angle of the interactive object based on the location of the interactive object and the user-height parameter; and
determining the target point of the interactive object based on the location of the interactive object and the angle of the interactive object.

18. One or more tangible, non-transitory, computer-readable media, comprising instructions that, when executed by at least one processor, cause the at least one processor to:
identify input from an interactive object held by a user in an interactive environment;
access a user profile associated with the user, the user profile comprising a user-height parameter of the user;
determine a target point of an interactive object based on the input and the user-height parameter of the user; and
adjust the user-height parameter in response to the target point being outside an adjustment plane of the interactive environment.

19. The one or more tangible, non-transitory, computer-readable media of claim 18, wherein the instructions cause the at least one processor to:
determine one or more calculated parameters based on the user-height parameter, the one or more calculated parameters comprising a reach of the user, a shoulder location of the user, or both, or a combination thereof; and
determine the target point of the interactive object based on the input, the user-height parameter, and the one or more calculated parameters.

20. The one or more tangible, non-transitory, computer-readable media of claim 18, wherein the instructions cause the at least one processor to:
update the user profile with the adjusted user-height parameter.
